(19) United States
(12) Patent Application Publication
(10) Pub. No.: US 2009/0079165 A1
(43) Pub. Date: Mar. 26, 2009

(54) Golf Cart

(76) Inventor: Gordon Liao, Yung Kang City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/859,121

(22) Filed: Sep. 21, 2007

(51) Int. Cl. B62B 1/10

(52) U.S. Cl. 280/646

(57) ABSTRACT

A golf cart includes an upper frame provided with a handlebar and a rotation articulation, a lower frame provided with an upper support seat and a lower support seat to support a golf bag for receiving golf clubs, and a link connected between the upper frame and the lower frame so that the upper frame and the lower frame are not located at the same line. Thus, the link connects the upper frame and the lower frame so that the rotation articulation on a lower end of the upper frame is not located at a central line of the lower frame and is deflected backward and upward to a rear side of an upper end of the lower frame, and a larger space is defined between the handlebar and a club head of each of the golf clubs.

### BACKGROUND OF THE INVENTION

1. Field of the Invention

The present invention relates to a cart and, more particularly, to a golf cart for carrying a golf bag.

2. Description of the Related Art

A conventional golf cart in accordance with the prior art shown in FIGS. 11-13 comprises an upper frame 1 provided with a handlebar, a lower frame 2 having an upper end and a lower end provided with an upper support seat 11 and a lower support seat 21 respectively to support a golf bag 20 for receiving golf clubs 22, and a rotation articulation 10 connected between the upper frame 1 and the lower frame 2. The rotation articulation 10 is located at a central line of the lower frame 2 so that the rotation articulation 10 and the lower frame 2 are located at the same line. The rotation articulation 10 is located at the lower end of upper support seat 11 to fold the upper frame 1 and the lower frame 2. However, the space defined between the upper frame 1 (or the handlebar) and a club head of each of the golf clubs 22 is too narrow so that a scoreboard 15 is not operated conveniently between the upper frame 1 (or the handlebar) and the golf clubs 22 as shown in FIG. 12. In addition, the rotation articulation 10 is located at the lower end of upper support seat 11 so that the upper frame 1 has a grater length. Thus, when the golf cart is folded, the upper frame 1 will interfere with the rear wheel 4 as shown in FIG. 13 so that the golf cart has a larger volume when the golf cart is folded, thereby greatly causing inconvenience in storage of the golf cart and thereby increasing the cost of transportation.

FIG. 14 shows another conventional golf cart. The rotation articulation 12 is mounted on a lower end of the upper frame 1 and is deflected from the center of the lower frame 2 through a determined distance so that the rotation articulation 12 and the lower frame 2 are not located at the same line. The upper frame 1 is provided with a slide 13 to lock the upper frame 1 and the lower frame 2 so as to expand the golf cart. However, the rotation articulation 12 is located at the lower end of upper support seat 11 so that the upper frame 1 has a grater length. Thus, when the golf cart is folded, the upper frame 1 will interfere with the rear wheel 4 so that the golf cart has a larger volume when the golf cart is folded, thereby greatly causing inconvenience in storage of the golf cart and thereby increasing the cost of transportation.

Another conventional golf cart in accordance with the prior art shown in FIG. 15 is a triple-folding type golf cart and comprises an upper frame 1, a lower frame 2, a middle frame 3 mounted between the upper frame 1 and the lower frame 2, an upper rotation articulation 14 mounted between the upper frame 1 and the middle frame 3, and a lower rotation articulation 16 mounted between the middle frame 3 and the lower frame 2. Thus, the golf cart has a smaller folded volume. The upper rotation articulation 14 is located at the upper end of upper support seat 11. However, the upper rotation articulation 14 is located at the central line of the middle frame 3, so that the space defined between the upper frame 1 (or the handlebar) and a club head of each of the golf clubs 22 is too narrow so that a scoreboard is not operated conveniently between the upper frame 1 (or the handlebar) and the golf clubs 22.

### BRIEF SUMMARY OF THE INVENTION

In accordance with one embodiment of the present invention, there is provided a golf cart, comprising an upper frame having an upper end provided with a handlebar and a lower end provided with a rotation articulation, a lower frame having an upper end and a lower end provided with an upper support seat and a lower support seat respectively to support a golf bag for receiving golf clubs, and a link connected between the upper frame and the lower frame so that the upper frame and the lower frame are not located at the same line. The link connects the upper frame and the lower frame so that the rotation articulation on a lower end of the upper frame is not located at a central line of the lower frame and is deflected backward and upward to a rear side of an upper end of the lower frame, and a larger space is defined between the handlebar and a club head of each of the golf clubs.

Preferably, the link has a first end connected with the rotation articulation and a second end connected to the upper end of the lower frame.

Preferably, the link has a first end integrally formed on the rotation articulation and a second end provided with a tube connected to the lower frame.

Preferably, the link has a first end connected with the rotation articulation, a second end connected to the upper support seat, and a mediate portion located between the first end and the second end and provided with a sleeve mounted on the upper end of the lower frame.

Preferably, the upper end of the lower frame is bent backward to form the link.

In accordance with another embodiment of the present invention, there is provided a triple-folding type golf cart, comprising an upper frame, a lower frame and a middle frame. A rotation articulation is mounted between a lower end of the upper frame and an upper end of the middle frame. The upper end of a middle frame is bent backward to form a link. The rotation articulation on the lower end of the upper frame is not located at a central line of the middle frame and is deflected backward and upward to a rear side of the upper end of the middle frame.

The primary objective of the present invention is to provide a golf cart, wherein the upper frame and the lower frame are not located at the same line, so that a larger space is defined between the handlebar and the club head of each of the golf clubs to facilitate operation of the scoreboard and to facilitate a user storing personal articles or hanging a water bottle conveniently.

Another objective of the present invention is to provide a golf cart, wherein the upper frame is deflected backward and a distance is defined between the upper frame and the lower frame, so that the length of the upper frame (or the handlebar) can be shortened to prevent the upper frame from interfering with the rear wheel when the golf cart is folded, and the golf cart has a smaller volume when being folded to facilitate storage of the golf cart and to decrease the cost of transportation.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a side view of a golf cart in accordance with the first preferred embodiment of the present invention.

FIG. 2 is a locally enlarged perspective view of the golf cart as shown in FIG. 1.

FIG. 3 is an exploded perspective view of the golf cart as shown in FIG. 2.

FIG. 4 is a folded view of the golf cart as shown in FIG. 1.

FIG. 5 is a side view of a golf cart in accordance with the second preferred embodiment of the present invention.

FIG. 6 is a locally enlarged exploded perspective view of the golf cart as shown in FIG. 5.

FIG. 7 is a side view of a golf cart in accordance with the third preferred embodiment of the present invention.

FIG. 8 is a locally enlarged exploded perspective view of the golf cart as shown in FIG. 7.

FIG. 9 is a side view of a golf cart in accordance with the fourth preferred embodiment of the present invention.

FIG. 10 is a folded view of the golf cart as shown in FIG. 9.

FIG. 11 is a side view of a conventional golf cart in accordance with the prior art.

FIG. 12 is a locally enlarged perspective view of the conventional golf cart as shown in FIG. 11.

FIG. 13 is a folded view of the conventional golf cart as shown in FIG. 11.

FIG. 14 is a side view of another conventional golf cart in accordance with the prior art.

FIG. 15 is a side view of another conventional golf cart in accordance with the prior art.

### DETAILED DESCRIPTION OF THE INVENTION

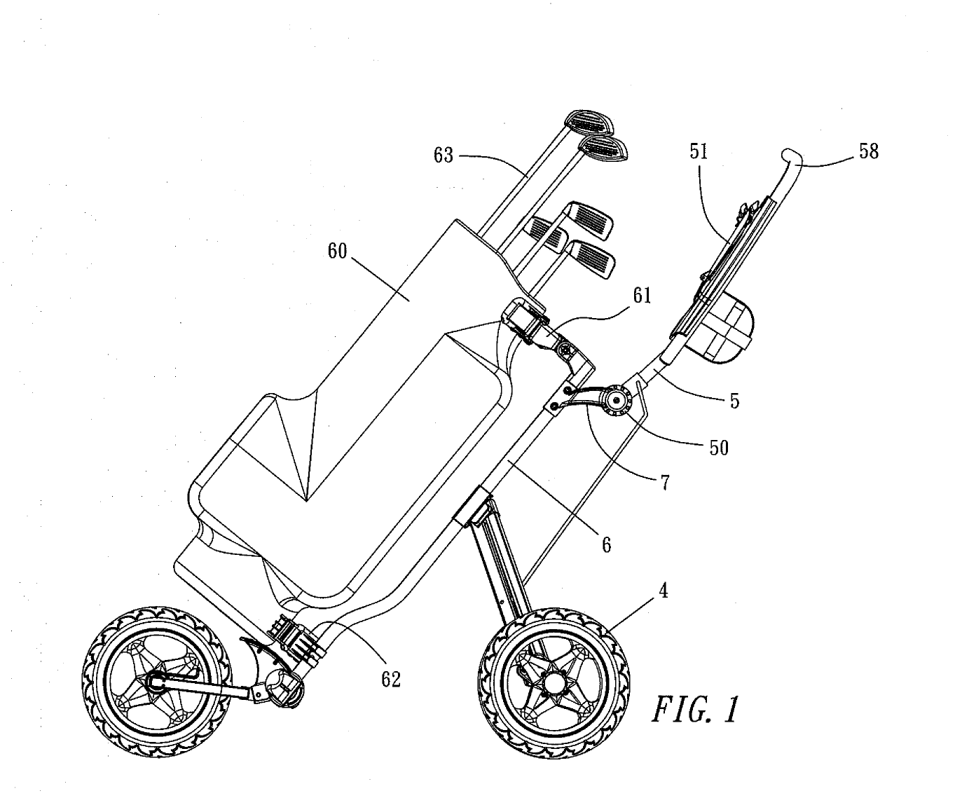

Referring to the drawings and initially to FIG. 1, a golf cart in accordance with the first preferred embodiment of the present invention comprises an upper frame 5, a lower frame 6, and a link 7. The upper frame 5 has an upper end provided with a handlebar 58 and a scoreboard 51 and a lower end provided with a rotation articulation 50. The lower frame 6 has an upper end and a lower end provided with an upper support seat 61 and a lower support seat 62 respectively to support a golf bag 60 for receiving golf clubs 63. The link 7 is connected between the lower end of the upper frame 5 and the upper end of the lower frame 6 so that the rotation articulation 50 on the lower end of the upper frame 5 is not located at the central line of the lower frame 6 and is deflected backward and upward to the rear side of the upper end of the lower frame 6, and the upper frame 5 and the lower frame 6 are not located at the same line.

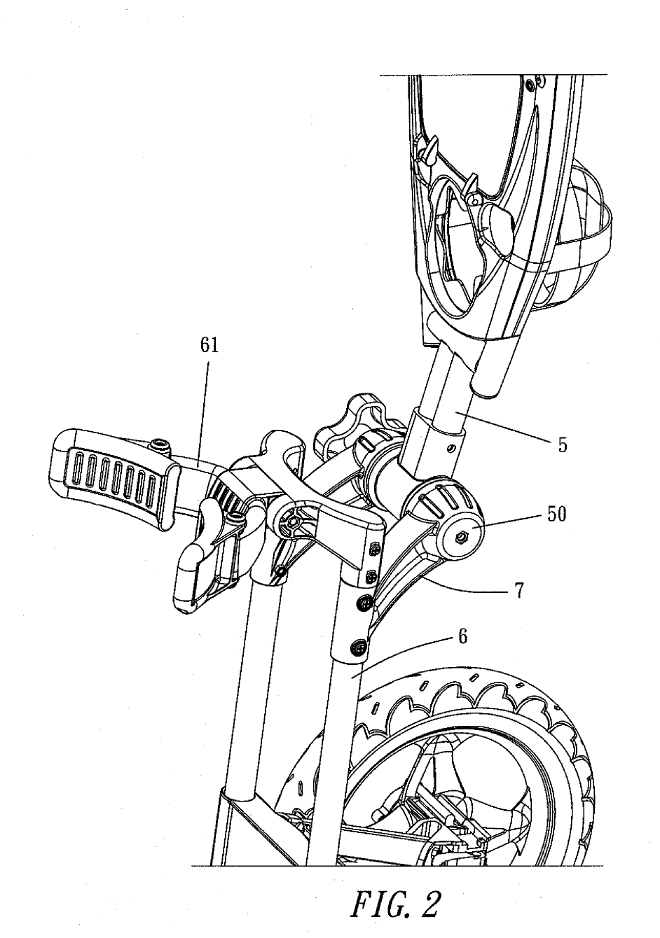

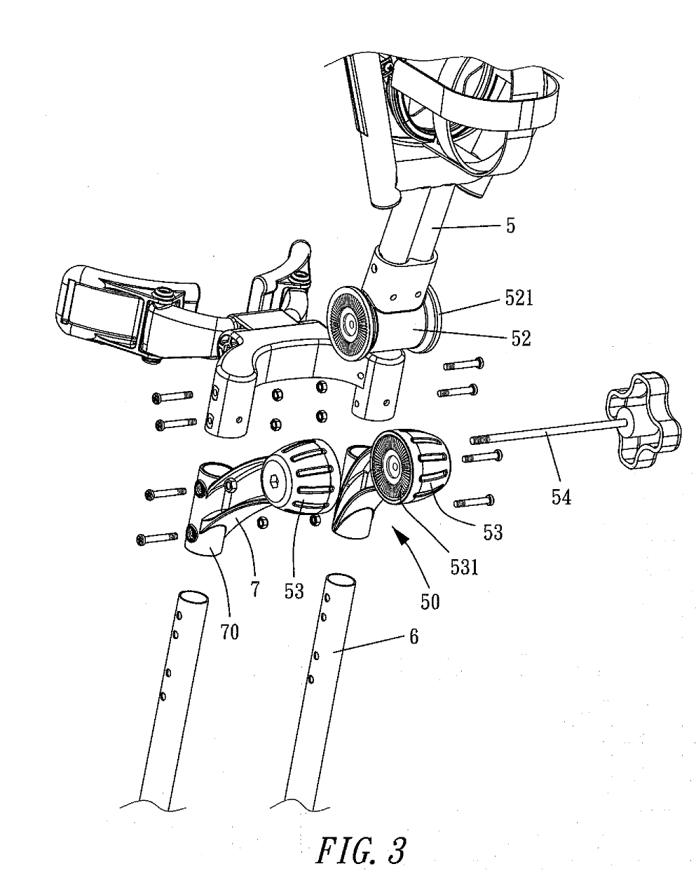

Referring to FIGS. 2 and 3, the rotation articulation 50 includes a main body 52 provided on the lower end of the upper frame 5 and having two opposite sides each provided with a disk 521 which is provided with an annular toothed portion, two opposite support brackets 53 each having an inner side provided with an annular toothed portion engaged with the annular toothed portion of the respective disk 521 of the main body 52, and a fixing member 54 extended through the main body 52 and the support brackets 53 to combine the main body 52 and the support brackets 53 together. Thus, when the fixing member 54 is released, the upper frame 5 is rotated through an angle by rotation of the main body 52 or directly folded. The structure of the rotation articulation 50 is conventional and will not be further described in detail.

Referring to FIG. 3, the link 7 has a first end connected with or integrally formed on the rotation articulation 50 (or each of the support brackets 53) and a second end provided with a tube 70 connected to the lower frame 6.

It is apparent that the link 7 is connected between the upper frame 5 and the lower frame 6 so that the upper frame 5 is deflected backward through a determined distance, while the rotation articulation 50 on the lower end of the upper frame 5 is not located at the central line of the lower frame 6 and is deflected backward and upward to the rear side of the upper end of the lower frame 6. Thus, the upper frame 5 and the lower frame 6 are not located at the same line, so that a larger space is defined between the handlebar 58 and the club head of each of the golf clubs 63 as shown in FIG. 1 to facilitate operation of the scoreboard 51 and to facilitate a user storing personal articles or hanging a water bottle conveniently.

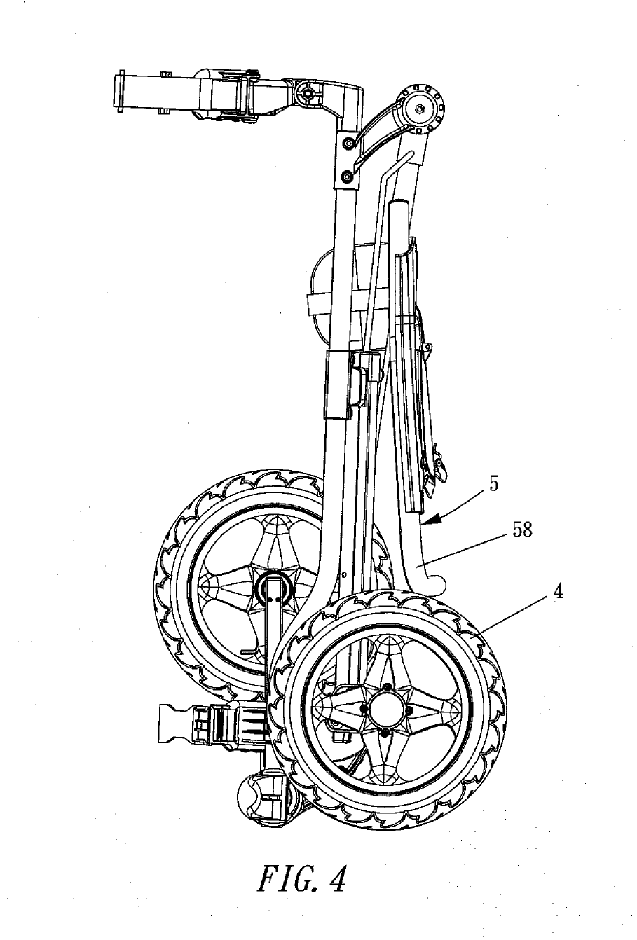

In addition, the upper frame 5 is deflected backward and a distance is defined between the upper frame 5 and the lower frame 6, so that the length of the upper frame 5 (or the handlebar 58) can be shortened to prevent the upper Frame 5 from interfering with the rear wheel 4 when the golf cart is folded. Thus, when the golf cart is folded, the golf cart has a smaller volume as shown in FIG. 4.

Accordingly, the upper frame 5 and the lower frame 6 are not located at the same line, so that a larger space is defined between the handlebar 58 and the club head of each of the golf clubs 63 to facilitate operation of the scoreboard 51 and to facilitate a user storing personal articles or hanging a water bottle conveniently. In addition, the upper frame 5 is deflected backward and a distance is defined between the upper frame 5 and the lower frame 6, so that the length of the upper frame 5 (or the handlebar) can be shortened to prevent the upper frame 5 from interfering with the rear wheel 4 when the golf cart is folded, and the golf cart has a smaller volume when being folded to facilitate storage of the golf cart and to decrease the cost of transportation.

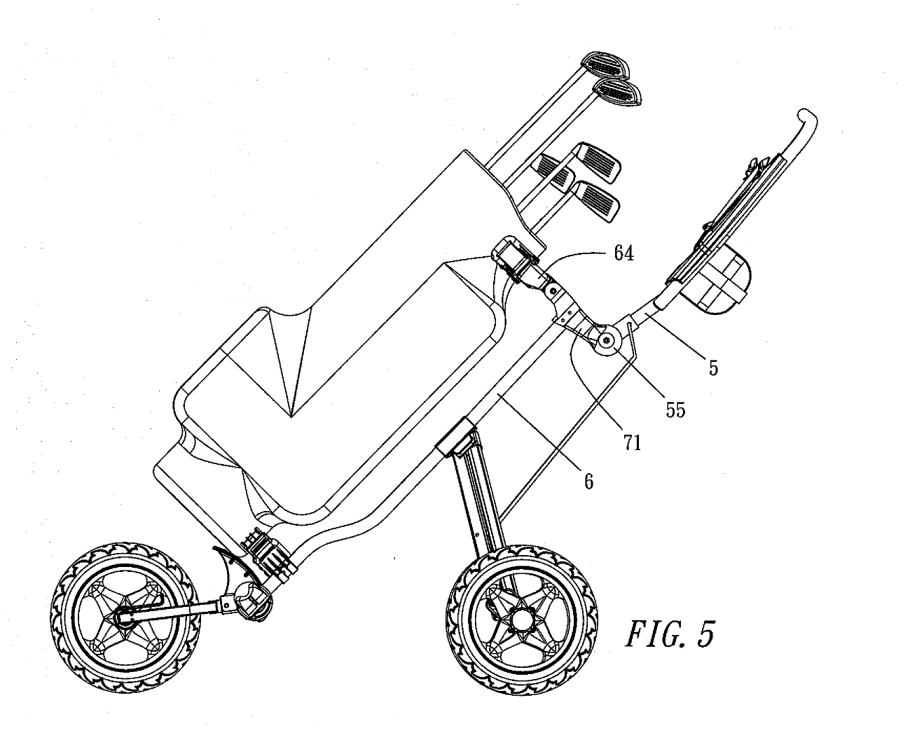

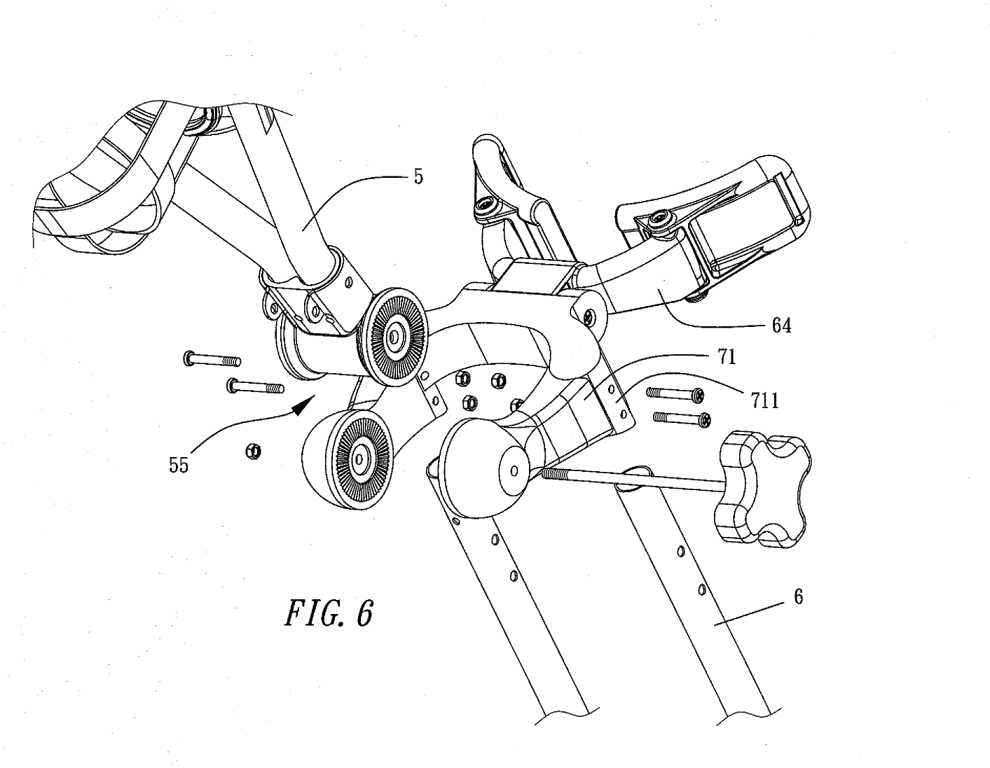

Referring to FIGS. 5 and 6, in accordance with the second preferred embodiment of the present invention, the link 71 has a first end connected with or integrally formed on the rotation articulation 55 (or each of the support brackets) and a second end connected to the upper support seat 64. The link 71 has a mediate portion located between the first end and the second end and provided with a sleeve 711 mounted on the upper end of the lower frame 6, so that the link 71, the rotation articulation 55 and the upper support seat 64 are combined integrally.

It is apparent that the rotation articulation 55 on the lower end of the upper frame 5 is not located at the central line of the lower frame 6 and is deflected backward and upward to the rear side of the upper end of the lower frame 6. Thus, a larger space is defined between the handlebar and the club head of each of the golf clubs, and the length of the upper frame 5 (or the handlebar) can be shortened to have a smaller folded volume to achieve the same effect as that of the first preferred embodiment of the present invention.

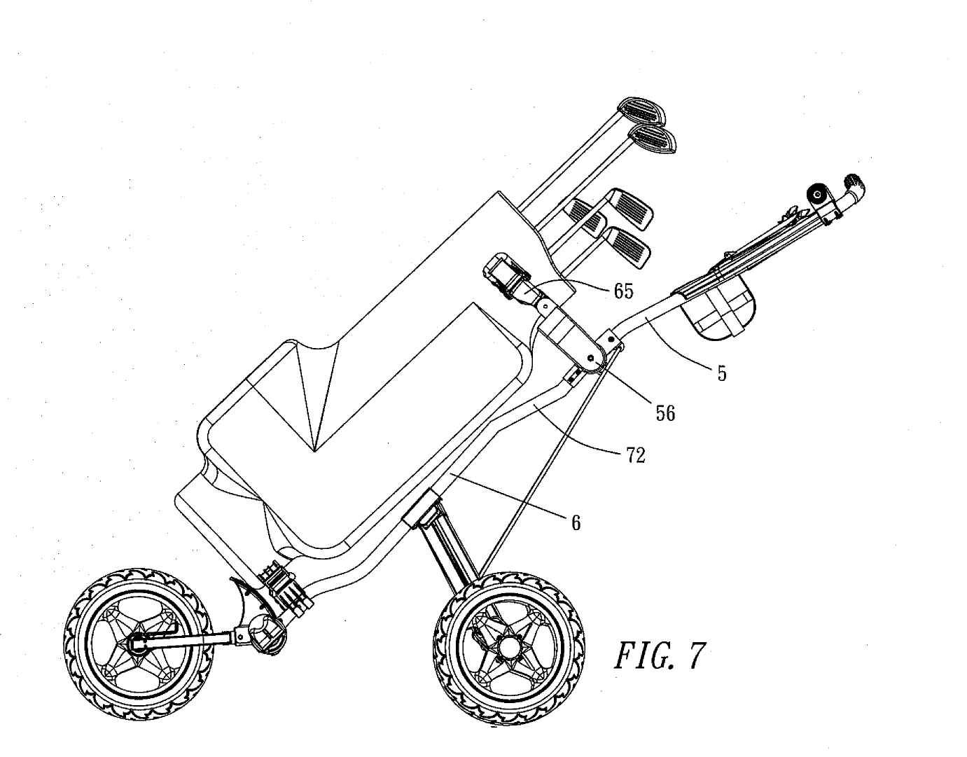

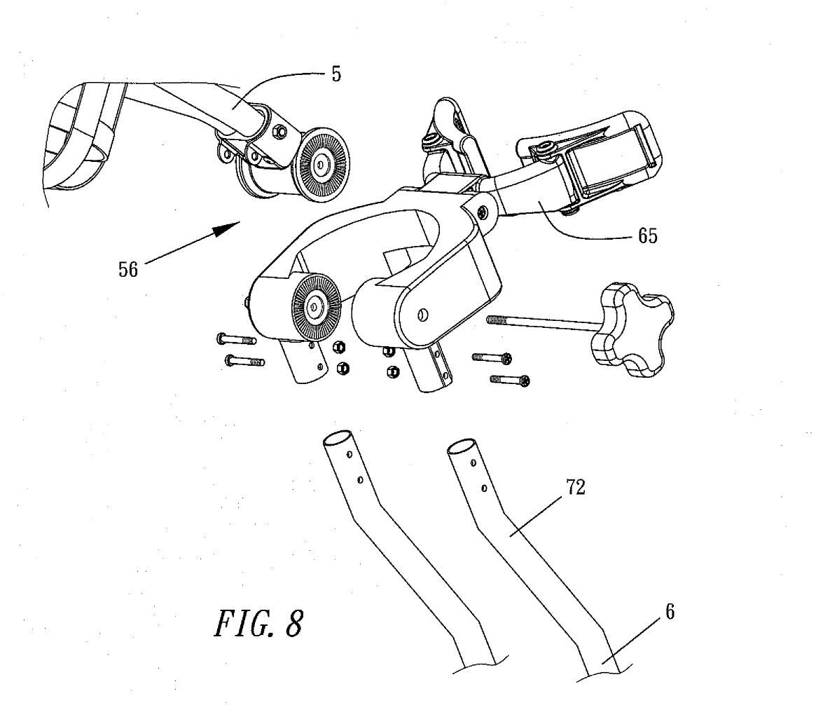

Referring to FIGS. 7 and 8, in accordance with the third preferred embodiment of the present invention, the upper end of the lower frame 6 is bent backward to form a link 72. The rotation articulation 56 (or each of the support brackets) on the lower end of the upper frame 5 is connected with or integrally formed on the upper support seat 65. Thus, the upper frame 5 is deflected backward through a distance, and the rotation articulation 56 on the lower end of the upper frame 5 is not located at the central line of the lower frame 6 to achieve the same effect as that of the first preferred embodiment of the present invention.

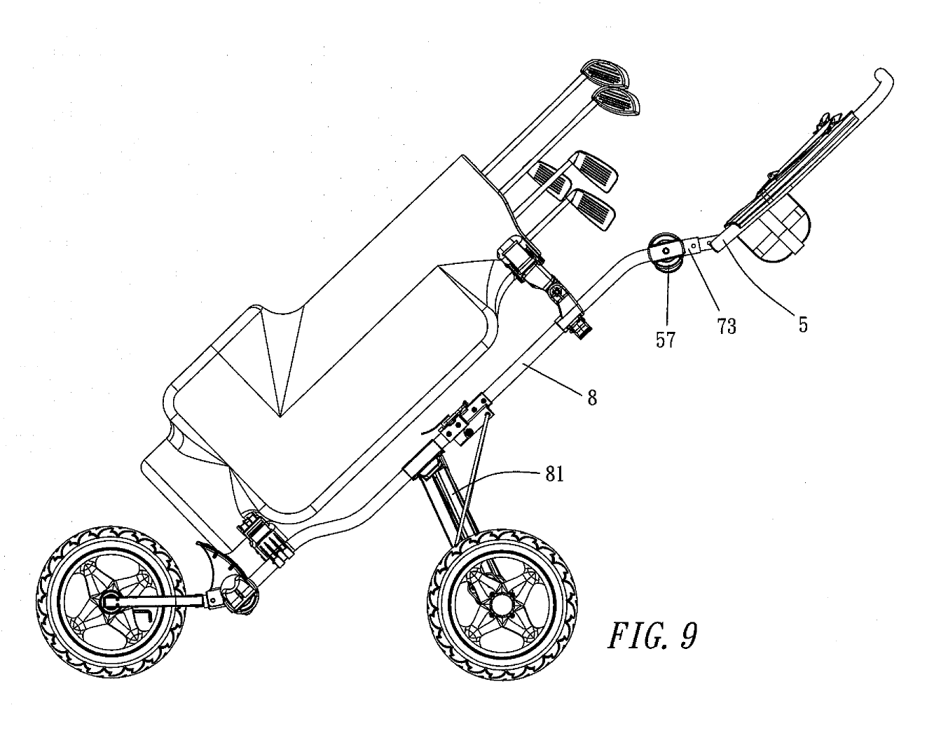

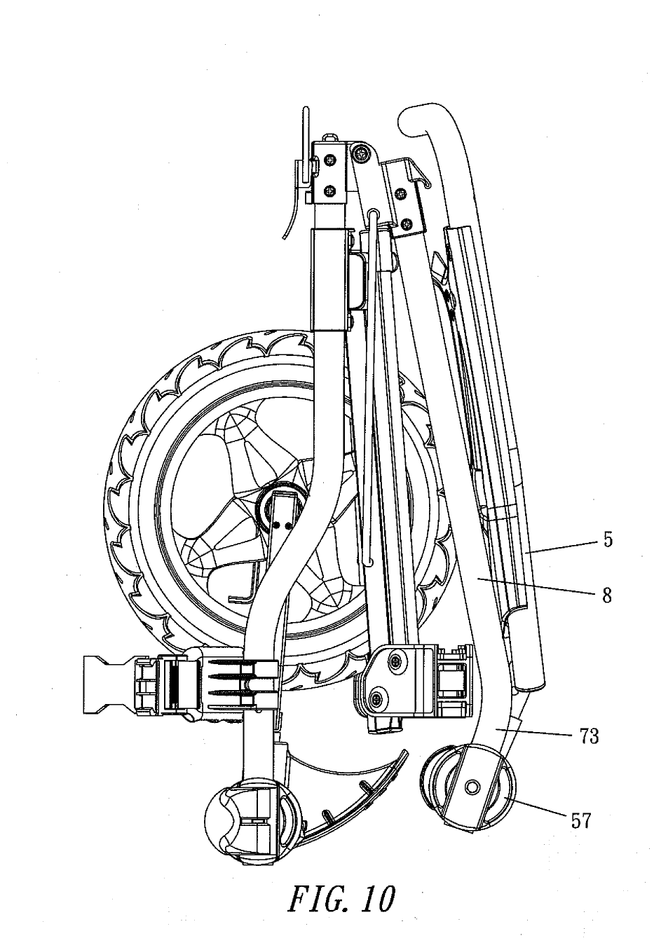

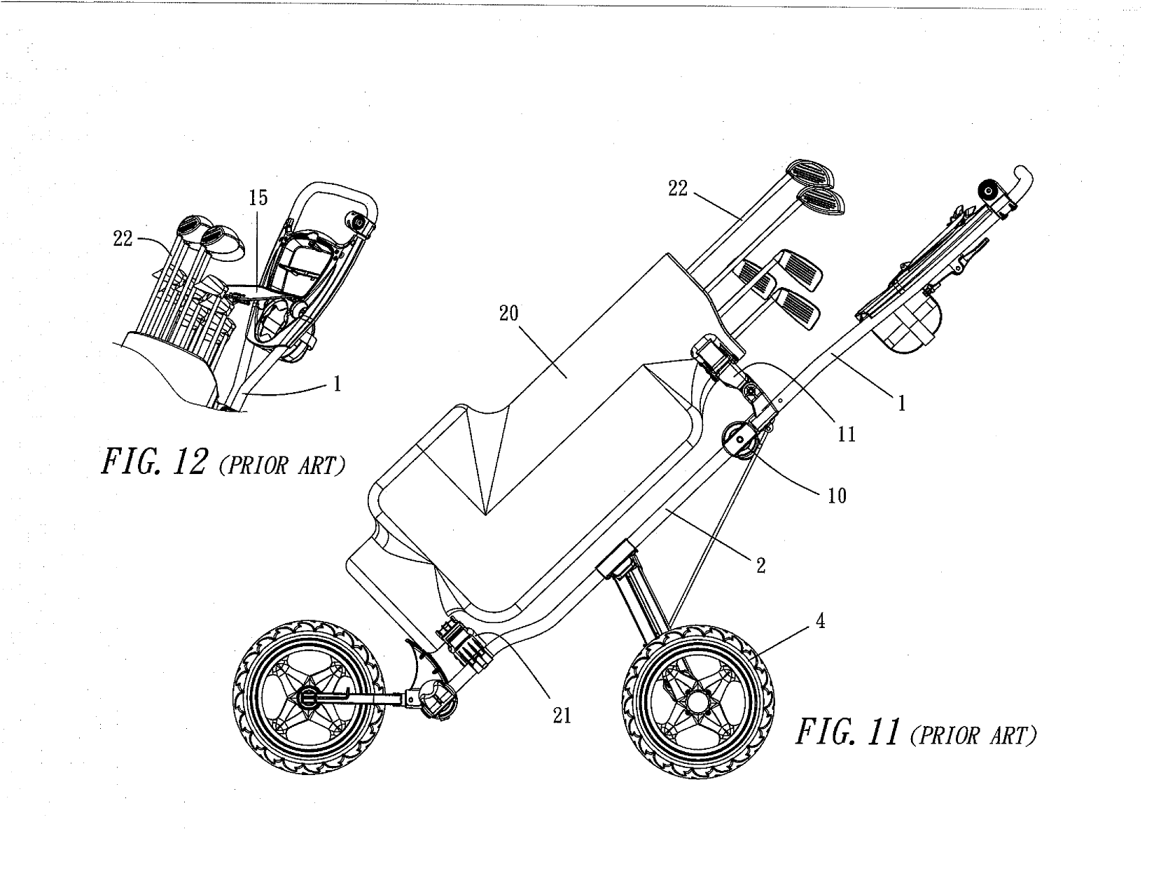

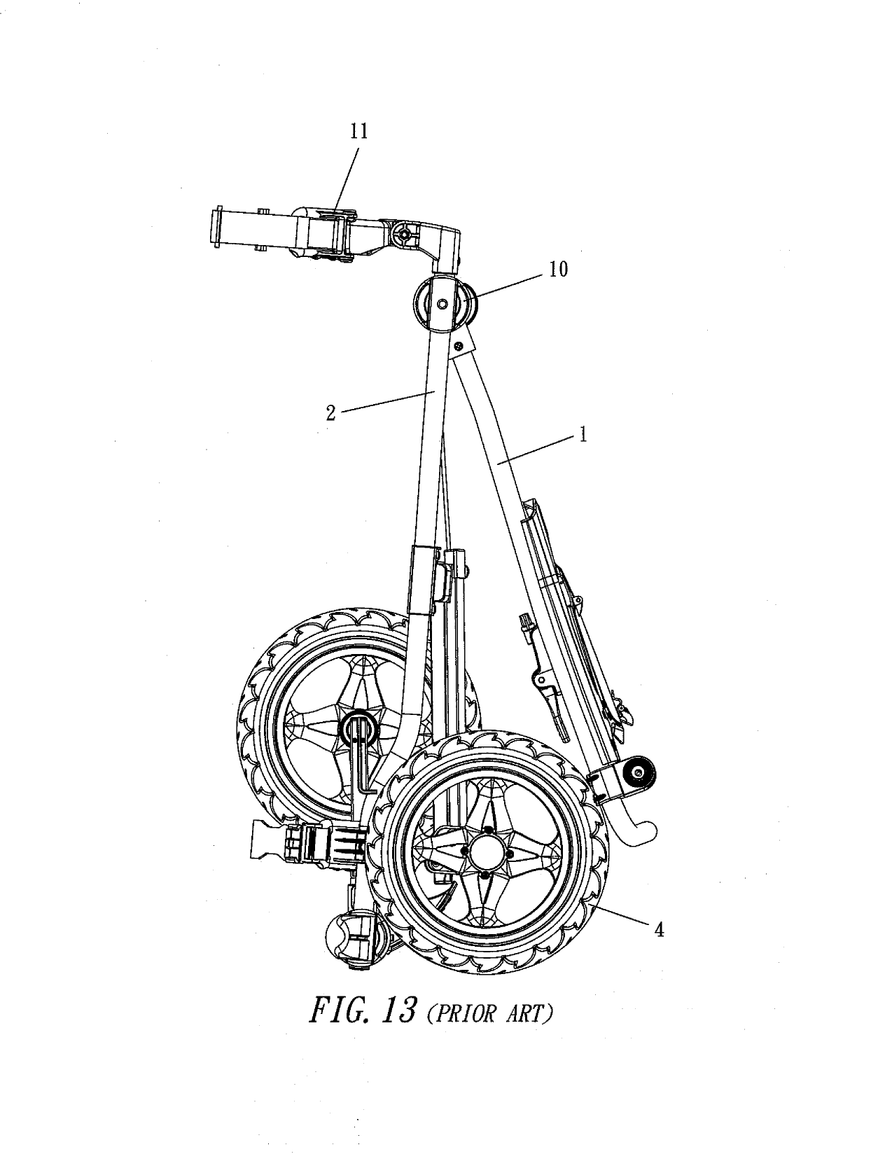

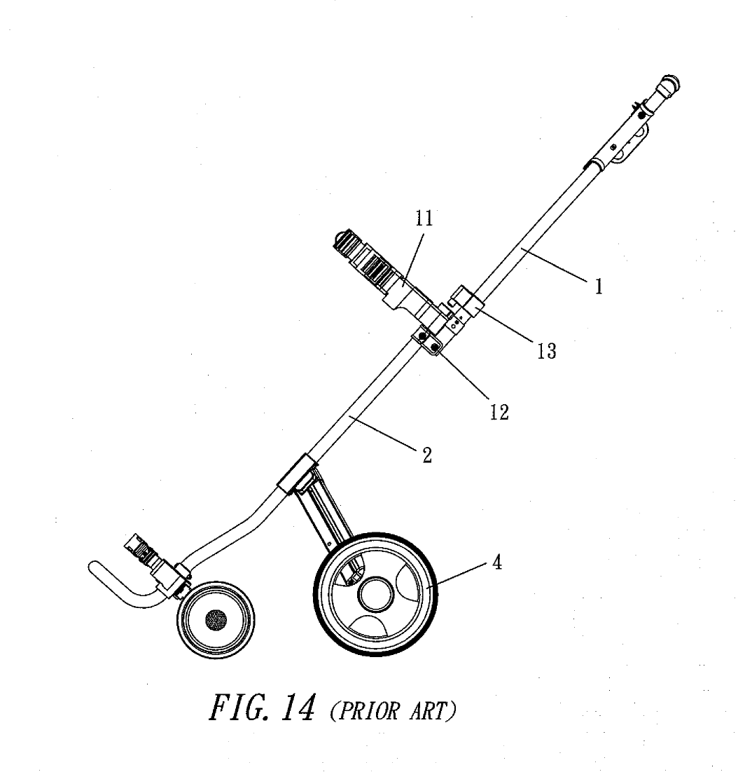

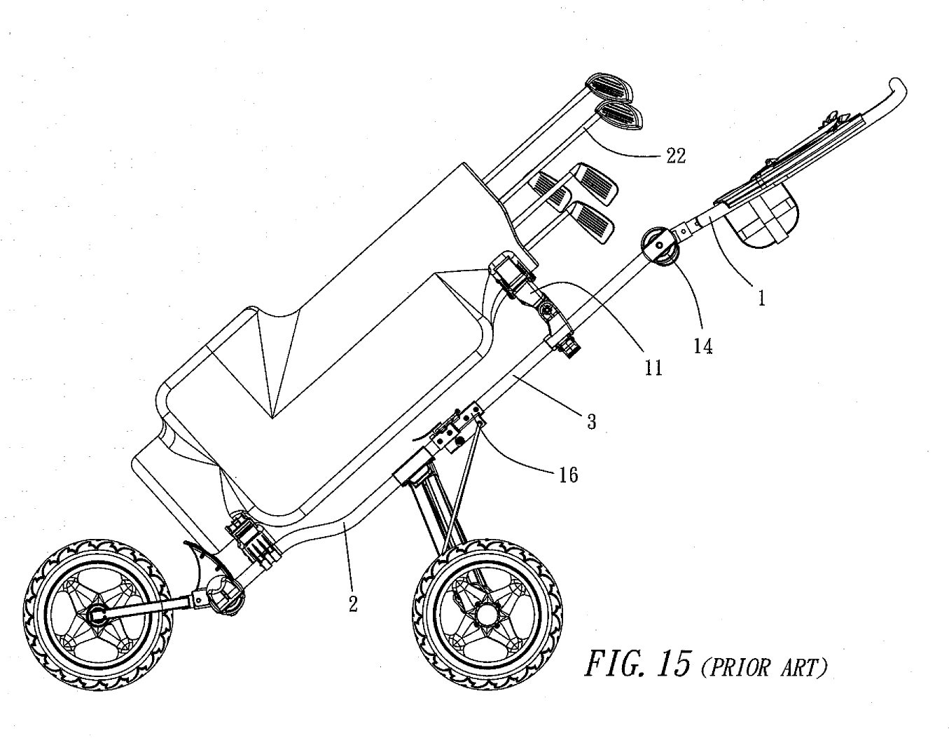

Referring to FIGS. 9 and 10, in accordance with the fourth preferred embodiment of the present invention, the golf cart is a triple-folding type golf cart. The rotation articulation 57 on the lower end of the upper frame 5 is mounted on an upper end of a middle frame 8. The upper end of a middle frame 8 is bent backward to form a link 73. The rotation articulation 57 on the lower end of the upper frame 5 is not located at the central line of the middle frame 8 and is deflected backward and upward to the rear side of the upper end of the middle frame 8, so that a larger space is defined between the handlebar and the club head of each of the golf clubs. At the same time, the upper frame 5 will not interfere with an axle coupler (not shown) of a foot tube 81 of a rear wheel so that the golf cart has a smaller volume when being folded as shown in FIG. 10.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A golf cart, comprising:
an upper frame having an upper end provided with a handlebar and a lower end provided with a rotation articulation;
a lower frame having an upper end and a lower end provided with an upper support seat and a lower support seat respectively to support a golf bag for receiving golf clubs;
a link connected between the upper frame and the lower frame so that the upper frame and the lower frame are not located at the same line; wherein
the link connects the upper frame and the lower frame so that the rotation articulation on a lower end of the upper frame is not located at a central line of the lower frame and is deflected backward and upward to a rear side of an upper end of the lower frame, and a larger space is defined between the handlebar and a club head of each of the golf clubs.

2. The golf cart in accordance with claim 1, wherein the link has a first end connected with the rotation articulation and a second end connected to the upper end of the lower frame.

3. The golf cart in accordance with claim 1, wherein the link has a first end integrally formed on the rotation articulation and a second end provided with a tube connected to the lower frame.

4. The golf cart in accordance with claim 1, wherein the link has a first end connected with the rotation articulation, a second end connected to the upper support seat, and a mediate portion located between the first end and the second end and provided with a sleeve mounted on the upper end of the lower frame.

5. The golf cart in accordance with claim 1, wherein the upper end of the lower frame is bent backward to form the link.

6. A triple-folding type golf cart, comprising an upper frame, a lower frame and a middle frame, wherein
a rotation articulation is mounted between a lower end of the upper frame and an upper end of the middle frame;
the upper end of a middle frame is bent backward to form a link;
the rotation articulation on the lower end of the upper frame is not located at a central line of the middle frame and is deflected backward and upward to a rear side of the upper end of the middle frame.
